(19) United States
(12) Patent Application Publication
(10) Pub. No.: US 2012/0235398 A1
(43) Pub. Date: Sep. 20, 2012

(54) DIVIDER TAB AND TAB LABELING SYSTEM FOR INFORMATION ORGANIZATION AND RETRIEVAL

(76) Inventor: Thomas Porzio, North Chesterfield, VA (US)

(21) Appl. No.: 13/421,834

(22) Filed: Mar. 15, 2012

Related U.S. Application Data
(60) Provisional application No. 61/454,093, filed on Mar. 18, 2011.

(51) Int. Cl. B42F 21/06

(52) U.S. Cl. 283/67; 283/36

(57) ABSTRACT

An integrated divider tab and tab labeling system is comprised of tabs at the bottom and side edges of bound material. Tabs are positioned and labeled to provide quick access to information of initial interest, then efficient maneuverability from one subject to another. Users of the system group information in general categories, then further organize each of the information groups into corresponding subgroups. Once each group and subgroup are labeled, the user saves time in finding and referring to information by following the natural thought process of first locating group, then subgroup. Thus a considerably more versatile divider tab system saves time both in compiling information and accessing it for productive use.

### CROSS-REFERENCE TO RELATED APPLICATIONS

This application claims the benefit of provisional application Ser. No. 61/454,093, filed 2011 Mar. 18 by present inventor, the contents of which are incorporated herein in its entirety.

### BACKGROUND

This invention relates to organizing bound information in a manner that facilitates efficient, on-demand information retrieval. This bound information presents itself in many forms, including binders, catalogues, study guides and planners. The object is to collate material and label it in a manner that facilitates timely access to specific material as it is needed. While there is a multitude of existing information organization and labeling methods, particularly employing dividers and tabs, many of them are configured such that tabs are crowded at the right edge of the binder, and as such force organization of information in broadly defined categories to minimize the number of tabs. This method results in organizing material in more broadly defined groups than would otherwise be the desired, such that finding specifically desired information is made more difficult. Additionally, tabs clustered at the right edge of the binder obscure view of one another, making effective location of material even more difficult. The market has long sought a means of effectively organizing information so that it can be more quickly accessed for use.

Bound information may be organized in a variety of patterns using a multitude of binding mechanisms and divider tab and labeling systems. Most systems focus on methods of organizing information with tabs extended at the right edge of the binder. These tabs are positioned and labeled in a wide variety of formats, with the common result being application to binders with only a few general subject areas requiring casual reference. When there are more than just a few general subject areas to reference, or repeated reference to several subject areas is needed within a short period of time, the typical right-edged stack of tabs is proven inefficient, especially as view of these tabs is obscured by one another. A system that provides a combination of improved tab visibility and information location is needed.

Some have responded to these inefficiencies by including divider tabs at the top edge of the bound material. These tabs are positioned and labeled in a wide variety of formats, with the common result appearing to be a simple extension of the right-edge method, as more space is provided at the top edge. While this approach may marginally reduce inefficiencies relating to crowded subject tabs at the right edge of the binder, it introduces a complication in that the binder must be rotated from the desktop position for the user to view tabs at the top edge of the binder. Alternatively, the user would have to stand up to view these top-edge tabs with the binder resting on the desktop. A system with tabs clearly viewable from the desktop position and operable by the seated user is needed.

Manufactured binder accessories tend to be designed for use in one position, sometimes leaving unused accessories from the purchased package to be stored for incorporation in a future binder, or left as waste. Divider tab systems and related accessories are prone to this problem. Some have attempted to solve this inefficiency by designing a divider tab system with moveable tabs at the top and side of the divider tab sheet. These systems add unnecessary bulk and complexity to what should be very simple applications. A means of reducing leftover divider tabs sheets is needed to increase cost efficiency.

In addition to tab size and position, labeling of tabs is integral to the level of effectiveness of divider tabs. Many systems indicate labeling of tabs on one side, the side viewable before divider sheets are turned. This method results in excessive and time consuming manipulation of the binder contents to find information once it is initially opened. Other formats allow for labeling on both sides of the tab by printing, folding, and inserting into position. The issue here is that organizing material via this method is tedious and time consuming, and the inserted labels tend to slip out of place and get lost. Yet others allow for separate labeling of the front and back side of the tab via adhesively attached labels. This method is tedious and consumes a lot of time. Additionally, they are very difficult to position and align for any useful purpose. What is needed is a labeling system that is easily formatted for printing and quickly attachable to both sides of the tab in the proper alignment.

### SUMMARY

In accordance with one embodiment an improved divider tab system is organized with a combination of section tabs at the bottom edge of the binder and subsection tabs at the right edge of the binder, each positioned in stair step fashion, sized and color coded so as to present a direct and distinguishable view between sections. The tabs are labeled on both sides in a manner that presents a clear view of the indicia from the initial, unopened position as well as from any other position where a combination of section and subsection material has been accessed.

In accordance with one embodiment an improved divider tab system will facilitate the natural tendency to first find a section (or chapter) then locate the desired subsection (or subchapter); to access information in a manner that spans subject areas, in effect moving from one idea to another within a broader contextual environment; and to apply to notebooks, planners, study guides, catalogues, and related computer versions to make locating and maneuvering from section to subsection more intuitive and efficient.

### ADVANTAGES

Accordingly, several advantages of one or more aspects are as follows: to provide divider tab and tab labels that facilitate organization of information, that are easy to label, that are directly viewable, that makes it easy to locate desired information quickly, that facilitate maneuvering from one information item to another, and that reduces the quantity of unused dividers. Other advantages of one or more aspects will be apparent from a consideration of the drawings and ensuing description.

### DRAWINGS—FIGURES

Having thus described the invention in general terms, reference will now be made to the accompanying drawings, which are not necessarily drawn to scale, and wherein:

FIG. 1 is a front view of a notebook cover.

FIG. 2 is a front view of the right side of a notebook with the cover opened.

FIG. 3 is a front view of a notebook opened to an interior section tab (3) and subsection tab (4).

FIG. 4 is a front view of a full sheet of printed tab labels.

FIG. 5 is a perspective view of an individual tab label (12) being positioned for use.

FIG. 6 is a perspective view of a combination tab and tab label (15) being positioned for use.

FIG. 7 is a perspective view of an alternative combination tab and tab label (17) being positioned for use.

FIG. 8 are front views of a divider tab sheet (19) with a tab (21) shown in two positions.

### DRAWINGS—REFERENCE NUMERALS

1 section tabs, front side

2 subsection tabs, front side

3 selected section tab

4 selected subsection tab

5 section tabs, back side

6 subsection tabs, back side

7 section tab indicia or labels

8 subsection tab indicia or labels

9 example front side tab label indicia

10 example back side tab label indicia

11 fold line

12 individual tab label pair removed from tab label sheet

13 folding of individual tab label or label portion of tab

14 tab

15 combination tab and tab label

16 divider tab sheet

17 combination tab and tab label alternative

18 binder

19 divider tab sheet

20 punched or perforated holes

21 bottom edge tab

22 untabbed bound information or divider sheet

### DETAILED DESCRIPTION

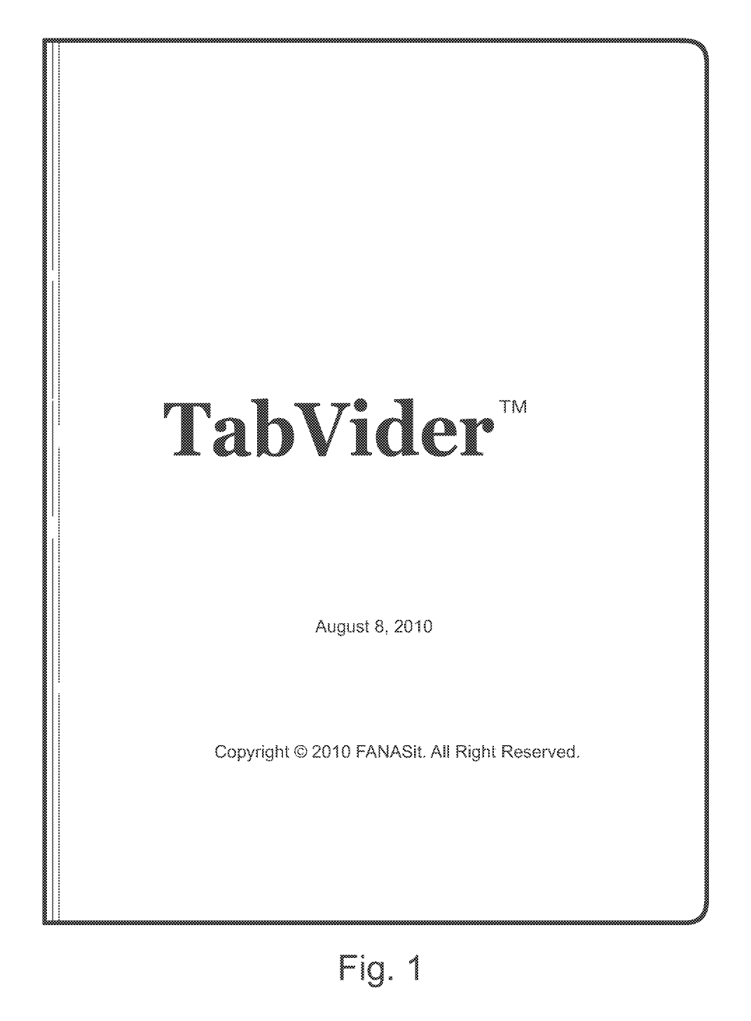

One embodiment illustrated in FIG. 1 is a front view of a closed notebook containing bound information with tabs generally not viewable as the cover protects said tabs.

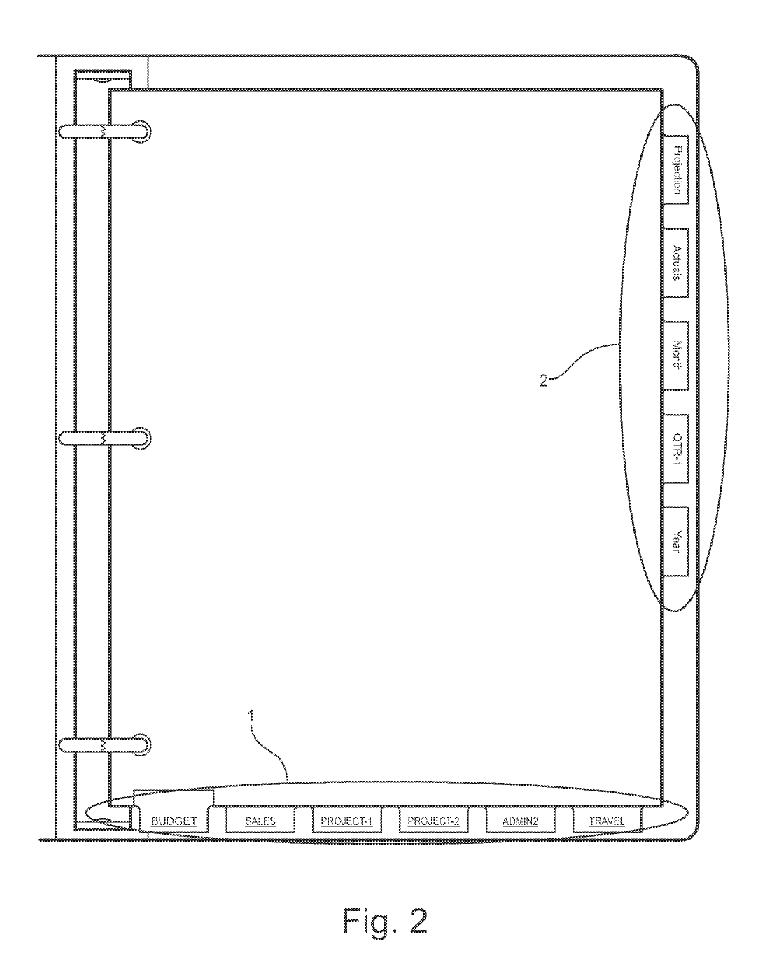

Illustrated in FIG. 2 is a front view of the right side of the notebook with the cover opened as a user would view it from a seated position with the notebook resting on a table in front of the user. Section tabs (1) are clearly visible along the bottom edge, and subsection tabs (2) of the first section are visible along the right side edge. The section tabs (1) are organized such that each section tab immediately precedes corresponding subsection tabs (2).

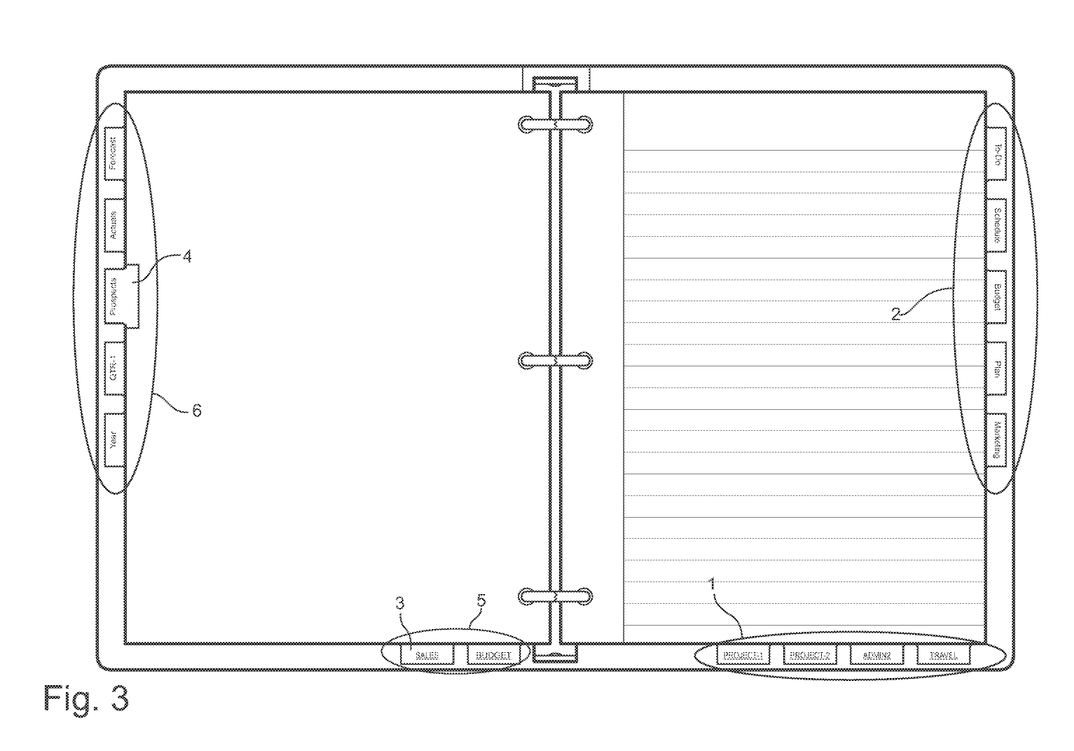

FIG. 3 is a front view of one version of the notebook opened to a selected section tab (3) and selected subsection tab (4) as a user would view it from a seated position with the notebook resting on a table in front of the user. Succeeding section tabs (1) and subsection tabs (2) are visible, similar to those of FIG.

2. The back side of preceding section tabs (5) and the back side of preceding subsection tabs (6) are visible at the bottom edge and left side edge of FIG. 3, respectively. Indicia are included on the front and back side of all tabs. Indicia can be comprised of any organized combination of alphanumeric figures, symbols, colors, fonts, etc. In the embodiment illustrated in FIG. 3, the indicia of the back side of each of the preceding section tabs (5) are designed to be read left to right, similar to the succeeding section tabs (1), although other configurations are within the scope of the present application. In the embodiment illustrated in FIG. 3, the indicia of the back side of each of the preceding subsection tabs (6) are presently contemplated to be designed to be read from bottom to top with the indicia of the front side of succeeding subsection tabs (2) designed to be read from top to bottom, although other configurations are within the scope of the present application.

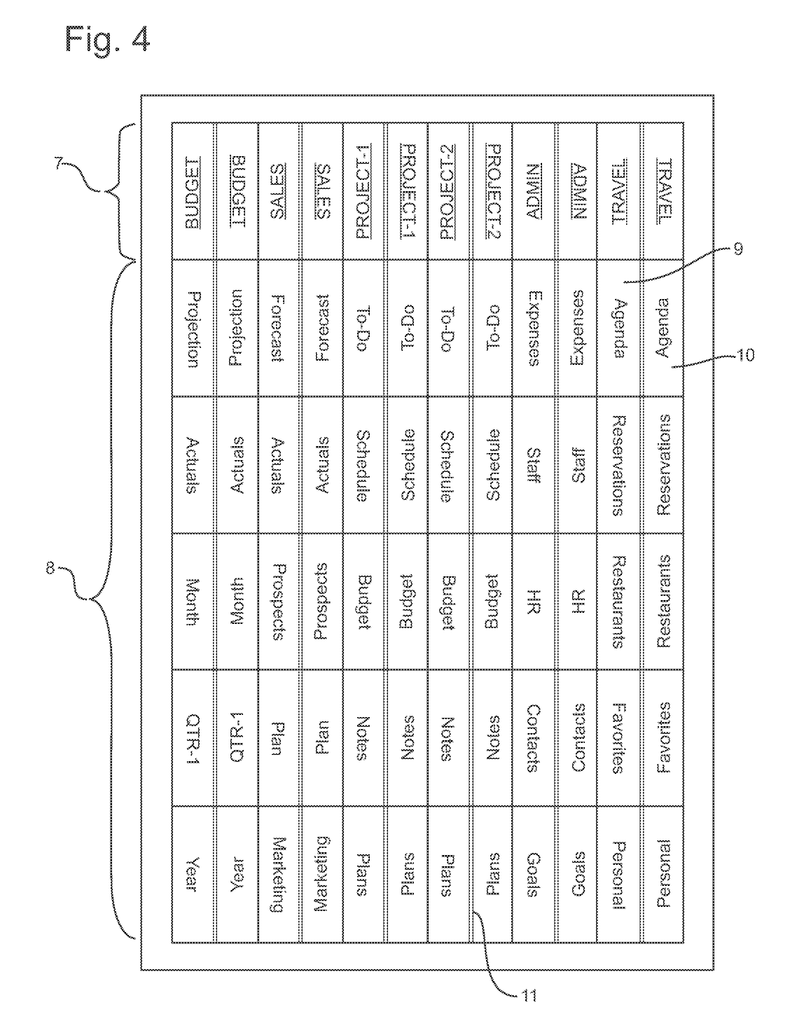

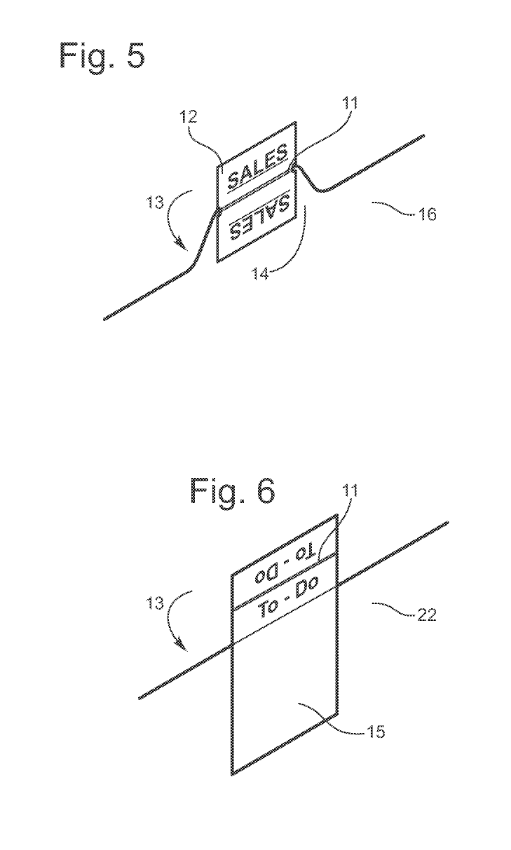

FIG. 4 illustrates a front view of a printed tab label sheet of one embodiment of the invention having section tab labels (7) formatted to correspond with their respective subsection tab labels (8), both of which include front-side (9) and back-side (10) label indicia as exemplified in the Agenda tab label. A common boundary of each side of each contiguous section or subsection label pair is a fold line (11). The fold line can be configured to cooperate with any of the three exposed edges of tab (14 in FIG. 5) employing a combination of indicia, perforations, geometric shapes, creases, notches, etc. FIGS. 5, 6, and 7 provide examples of several alternative embodiments of tab labels, all of which can be printed similar to the embodiment shown in FIG. 4.

FIG. 5 is a perspective view of one embodiment of a tab label pair (12) detached from the label sheet (such as the label sheet illustrated in FIG. 4) and in the process of being folded (13) along the fold line (11) and adhesively or removably mounted to the tab (14) and divider (16).

An alternative embodiment is a combination tab and tab label as shown in FIG. 6 in a perspective view of a typical combination tab and tab label (15) being affixed to a tabbed or untabbed information or divider sheet (22) and in the process of being folded (13) near the label end along the fold line (11) to provide front side and back side labels. The one-piece tab and tab label (15) is detached from a printed label sheet and removably or permanently affixed directly to a bound information or divider sheet (22), with the combination tab and tab label (15) serving as both tab and tab label.

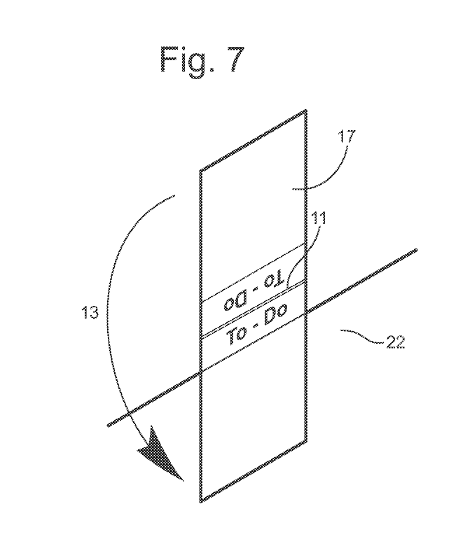

Another alternative embodiment is a combination tab and tab label as shown in FIG. 7, which is a perspective view of a combination tab and tab label (17) affixing on both sides of a tabbed or untabbed information or divider sheet (22) and in the process of being folded (13) at the fold line (11) to provide front side and back side labels. The one-piece tab and tab label (17) is detached from a printed label sheet and attached to a bound information or divider sheet (22) with tab label (17) serving as both tab and tab label.

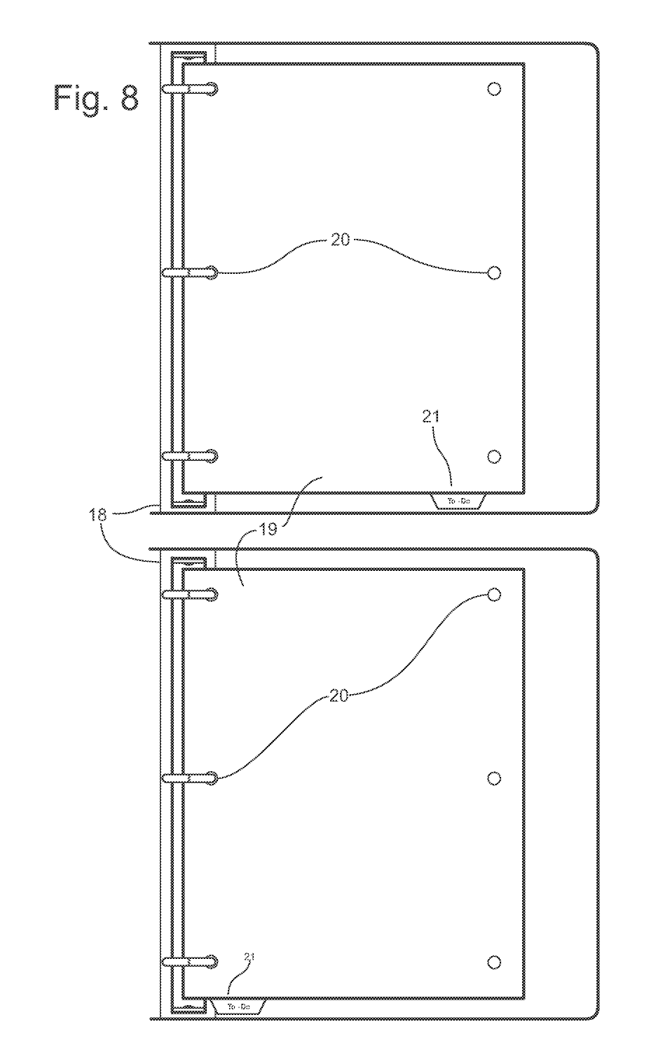

FIG. 8 is a front view of a presently contemplated divider tab sheet (19) with perforated or fully cut binder ring holes (20) on both side edges to allow for mounting of the divider tab sheet in a binder (18) in one of two alternative positions for employment of the bottom edge tabs (21) in one of two positions. However, the divider sheet can be tabbed or untabbed or other binding means may be used. Bottom edge tabs such as (21) extend beyond the bound material to the extent sufficiently far to be visible when the binder cover is opened but not too far to ensure that they are protected by the bottom edge of the binder covers. The divider tab sheet (19) with binder ring holes (20) and example tab (21) cooperates with section tabs (1 and 5) in FIGS. 2 and 3 employing tab labels (7) in FIG. 4. Alternative configurations shown in FIGS. 5, 6, and 7 may be employed in place of tab (21).

### Operation

The manner of using the divider tab and tab labeling system is to organize information into subject area sections (1) and detailed information subsections (2) using integrally descriptive indicia to label each tab (7 and 8) to efficiently access desired information for use as needed. Physical organization of information associated with tab placement operates cooperatively and interdependently with tab indicia (tab labels shown in FIGS. 4, 5, 6, and 7) to organize and locate information on demand

There are various possibilities for organizing bound information with tabs at both the bottom edge of and side edges of a notebook. In one embodiment shown in FIGS. 2 and 3 the user first categorizes information into sections (1). This section information is further organized into subsections (2), or more focused aspects of each section. The section tabs (1) are initially positioned at the bottom edge on the right side of the open notebook, with corresponding subsection tabs (2) initially positioned at the right side edge. However, information can be organized differently, for example with the section tabs at the initial right side edge with corresponding subsections at the bottom edge.

In the first embodiment the first section tab (BUDGET in this case) is placed at the top of the bound material as the leftmost tab in FIG. 2, with the respective subsection tabs (2) immediately following this section (in this case Projection, Actuals, Month, QTR-1, Year). The remaining section tabs are placed in succession to the right of the first section tab (in this case SALES, PROJECT-1, PROJECT-2, ADMIN2, TRAVEL as shown in FIG. 2) with their respective subsections following in the same manner The sections appear left to right in stair step fashion, with the first at the left (BUDGET in this case) and the others in sequence progressing toward the right. Each group of subsection tabs are positioned beginning at the binder top, right edge and progressing in sequence toward the bottom, right edge in stair step fashion. Each subsequent group of subsection tabs start again at the top, right edge and progress in sequence toward the bottom, right edge. The interdependent and cooperative relationship between the physical divider tabs and tab indicia (or labels) is shown by example in FIG. 2 where the BUDGET section tab correlates with its viewable subsection tabs (Projection, Actuals, Month, QTR-1, Year) and in the leftmost column pair in FIG. 4 headed by BUDGET tab indicia followed by the same subsection indicia. Alternative tab placement is possible, for example the first accessible subsection tab (or topmost tab) may be placed at the bottom, right edge of the binder with additional subsections placed in succession toward the top of the right side edge, or the first available section tab at the bottom, right edge of the binder with other sections placed in succession toward the left side edge, or other patterns may be used for both bottom and side tabs placement.

Information organized according to the first embodiment is efficiently identified employing indicia shown in FIG. 4 where sections are distinguishable by indicia (7) in the top row, are placed on divider tabs as shown in FIG. 5, and are displayed for use in FIG. 3 section tabs (1 and 5) at the bottom edge of the notebook. Subsection tab indicia (8) of FIG. 4 cooperate with their respective section tab indicia (7). Both distinction between section tab (1 and 5) members and cooperation between section tabs (1 and 5) and their respective subsection tabs (2 and 6) is achieved by indicia design that is integrated into the tab organization methodology. For example the SALES section tab (3) in FIGS. 3 and 4 may be in bold, underlined, uppercase lettering with a yellow background and its subordinate subsection Prospects tab (4) may be in bold, mostly lowercase lettering with a yellow background. Alternative indicia designs can be comprised of any combination alphanumeric figures, symbols, colors, fonts, etc. to achieve both the distinction between section tabs (and their respective subsection tabs) and cooperation between each section tab and its respective subsection tabs.

Tab indicia can be applied to tabs using various means of direct printing or using templates printable onto precut tab labels. I presently contemplate using commercially available software to print tab indicia (tab labels) in sheet form as shown in FIG. 4 for application to fixed tabs as shown in the example in FIG. 5. The tab labels are accurately and consistently mounted to tabs employing alignment means such as printed fold lines (11), perforations, notches, etc. The tab labels shown in FIG. 4 are detachable from the printed sheet and attachable to the tab as shown in FIG. 5. All section and subsection tabs are labeled on both front and back sides as shown for example in the SALES and BUDGET tabs in FIG. 2 (front side of tabs) and FIG. 3 (back side tabs (5)), such that each section is distinguishable from the other and color or other indicia is used such that subsections correspond with their respective sections. Various alternative tab and tab labeling means are possible. For example, a combination tab-label (FIGS. 6 and 7) can be printed and attached to the information or divider sheet (22).

Selection and alternative positioning of tabbed dividers is made more efficient using divider tabs that may be leftover from previously opened packages. For example in FIG. 8 section tab (21) can be positioned in a first position employing the leftmost binder holes or in a second position employing the rightmost binder holes. Any of the section tabs (1) in FIG. 3 can be positioned in alternative positions as shown by example in FIG. 8 to provide the most efficient use of divider tab supplies.

Once information is organized and tabs are labeled as shown in the Figures the divider tab system is ready for productive use. Referring initially to FIG. 2 and then to FIG. 3 for example the user selects the desired SALES subject tab (3) from those displayed on section divider tabs (1) at the bottom edge of the notebook. Opening (or turning the page) to the desired section tab (3) repositions section tab (3) from a first position on the right side of the binder to a second position on the left side of the binder and initially exposes related subsections (2) to direct view at the right edge of the notebook. As the example continues the desired subsection tab (4) is opened in a page-turning manner to expose the desired detailed information (Prospects in this case). Once the information of initial interest is found, the user can maneuver back and forth between sections and subsections to quickly access information as it is needed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I claim:

1. A method of organizing and accessing information, comprising:
a. segregating said information into subject sections and assigning associated physical and visual identifiers; and
b. organizing each said segregated subject section into useful information subsections and assigning associated physical and visual identifiers subordinate to their respective subject section identifier;
Whereby each of said subject sections comprises physical and visual identifiers that distinguishes each subject section from one another and urges association with its corresponding subordinate group of subsection physical and visual identifiers; and whereby each group of subsections comprises physical and visual identifiers that urges association with its corresponding subject section for expeditious location and retrieval of specifically desired information on demand.

2. The method of claim 1, further comprising applying indicia to said sections and subsections, said indicia designed to both distinguish said sections from one another and associate said sections with their respective information subsections.

3. The method of claim 1, further comprising collating said information in a notebook disposed to urge pivotal operation of a section divider tab to present a desired subsection of divider tabs for physical retrieval of information contained in a selected subsection member tab.

4. A divider tab and tab labeling system, comprising:
a. a plurality of section divider tabs disposed along a first edge of bound material such that each of the plurality of section divider tabs is in direct view of a user; and
b. a plurality of groups of subsection divider tabs disposed along a second edge of said bound material, each group of subsection divider tabs being subordinate to a corresponding one of said plurality of section divider tabs;
wherein each of said plurality of section divider tabs comprises indicia that distinguishes each section divider tab from one another and urges association with its corresponding subordinate group of subsection divider tabs; and wherein each group of subsection divider tabs comprises indicia that urges association with its corresponding section divider tab.

5. The divider tab and tab labeling system of claim 4 wherein said first plurality of divider tabs is disposed along a bottom binder edge nearest the user and said second plurality of divider tabs is disposed along a side edge of the binder.

6. The divider tab and tab labeling system of claim 4 wherein said first plurality of divider tabs and tab labels define general subject sections that are further subdivided into subsections of information defined by members of said second plurality of divider tabs and tab labels.

7. The divider tab and tab labeling system of claim 4 wherein an approximate 180 degree pivotal operation of any member of the of the first plurality of divider tabs from a first position where the divider tab is on a right side of an open binder to a second position where the divider tab has been pivotally repositioned to a left side of the open binder presents the respective subordinate second plurality of divider tabs to direct view along the right side edge of the binder.

8. The divider tab and tab labeling system of claim 4 wherein indicia of the first plurality of divider tabs are designed to urge differentiation among member tabs and to urge correlation with indicia of their respective second plurality divider tab subsections.

9. The divider tab and tab labeling system of claim 4, further comprising tab indicia having means for urging disposition of said indicia on both sides of each divider tab with consistent alignment with other tab indicia along a common binder edge.

10. The divider tab and tab labeling system of claim 4, further comprising indicia on the first plurality of divider tabs read from left toward right from both a first position where the divider tab is on a right side of an open binder and a second position where the divider tab has been pivotally repositioned to a left side of the open binder.

11. The divider tab and tab labeling system of claim 4, further comprising tab indicia on the second plurality of divider tabs read from top to bottom when in a first position where the divider tab is on a right side of an open binder and bottom to top when in a second position where the divider tab has been pivotally repositioned to a left side of the open binder.

12. The divider tab and tab labeling system of claim 4 wherein the divider tabs are disposed in cooperation with tab indicia to maximize direct view of divider tabs.

13. The divider tab and tab labeling system of claim 4 wherein said divider tabs are disposed within the protective perimeter of the binder cover.

14. The divider tab and tab labeling system of claim 4 wherein the tab portion of the divider is contiguous with the divider page.

15. The divider tab and tab labeling system of claim 4, further comprising connecting means on opposing sides of the divider tab page such that the tab portion of the divider can be disposed in at least two locations.

16. A divider tab and tab labeling system, comprising:
a. indicia means simultaneously distinguishing members of a first plurality of divider tabs and cooperating with a second plurality of divider tabs indexed by said first plurality divider tabs; and
b. affixing means providing alignment of said indicia with each tab;
whereby divider tabs are labeled in cooperation with their physical disposition to precisely align indicia on each divider tab; and whereby alignment of divider tab indicia along a common binder edge is achieved.

17. The divider tab and tab labeling system of claim 16, further comprising at least one of markings, geometric shapes, creases, notches, or perforations urging consistent alignment of tab indicia.

18. The divider tab and tab labeling system of claim 16, further comprising indicia printed on label sheets containing a multiplicity of precut tab labels disposed for permanent or removable affixing of label pairs to dividers.

19. A divider tab and tab labeling system, comprising:
a. a plurality of labeled section divider tabs disposed along a first edge of bound material such that each of the plurality of labeled section divider tabs is in direct view of a user; and
b. a plurality of groups of labeled subsection divider tabs disposed along a second edge of said bound material, each said group of subsection divider tabs being subordinate to a corresponding one of said plurality of section divider tabs;
wherein each of said plurality of labeled section divider tabs comprises combination label-tabs adhesively placed on section sheets; and wherein each group of subsections comprises combination label-tabs adhesively placed on subsection sheets.

20. The divider tab and tab labeling system of claim 19, further comprising at least one of markings, geometric shapes, creases, notches, or perforations urging precise alignment of label-tab indicia with its respective section or subsection sheet and with other label-tabs along a common binder edge.
